(19) United States
(12) Patent Application Publication
(10) Pub. No.: US 2010/0138314 A1
(43) Pub. Date: Jun. 3, 2010

(54) METHOD FOR PROVIDING MICRO BILLING FOR GENERIC INTERNET SERVICE IN AN ACCESS NETWORK

(76) Inventors: Jun Li, Tenafly, NJ (US); Junbiao Zhang, Bridgewater, NJ (US); Kumar Ramaswamy, Princeton, NJ (US)

Correspondence Address: Robert D. Shedd, Patent Operations;THOMSON Licensing LLC, P.O. Box 5312, Princeton, NJ, 08543-5312, US

(21) Appl. No.: 12/452,366

(22) PCT Filed: Jun. 28, 2007
(86) PCT No.: PCT/US07/15244

§ 371 Date: Dec. 28, 2009

(51) Int. Cl. G06Q 30/00; G06F 15/16; G06F 3/048

(52) U.S. Cl. 705/27; 705/34; 709/227; 715/810

(57) ABSTRACT

The method for providing micro-billing for internet services includes establishing a micro-billing agent (MBA) within a user's access point (i.e., Internet Service Provider—ISP). The MBA contains the user's billing information and keeps that information exclusive to the MBA. By retaining the user's information with their access point, the user can conduct more secure online transactions, particularly for low cost transactions, without the inconvenience of inputting or transferring personal purchasing information to the online store. According to one aspect, the purchase page may be previously encoded with a micro-billing option which would enable the MBA to obtain user authorizations in online transactions in a more streamlined and secure manner.

### BACKGROUND

1. Field of the Technology

The present principles relate to micro billing for online transactions.

2. Description of Related Art

Micro billing is an important issue for pay-per-transaction based Internet/online services. The regular payment mechanism could become a major nuisance to both the service providers and the customers who frequently engage in transactions that cost only a small amount of money (e.g. downloading of ring tones, or MP3 music files).

By way of example, a customer of a wireless network access provider (ISP) uses his mobile device to access an Internet music store through his wireless ISP. He decides to buy an MP3 song which costs $0.80. However, he does not have an account with the online store or even if he has an account, he does not want to put his credit card information in for a sub-dollar charge. As a consequence, the music store loses its business just because cost is too small for each transaction.

This problem will become very serious for online purchases of digital content. Even for large size content, like a movie, it may only cost a few dollars, which is still too small for a customer to use a credit card for the transaction for both security and convenience concerns.

Today, there are solutions such as Yahoo-purse, etc. that aim to solve this problem. However, in each case, this is based on a static relationship between the content provider and the user of the service.

There are two approaches that online systems currently use for micro billing. First is to bundle the pay service with network access service. For example, ring tone downloading service is a feature provided by cellular mobile networks. Although the ring tone service may be operated by different entities, the billing of each download will only appear on cellular subscriptions monthly bill. The second approach is to use another Internet service as a billing agent to accumulate micro bills. For example, Yahoo Purse, etc., can be used to pay online purchase at stores that have partnership with yahoo. The user's credit card information is stored only at the other Internet service (i.e., Yahoo Purse, etc.) This is a safer solution than the first, however, a customer may not want to build a separate account on Yahoo or other provider, and keep their credit card information there. Also, each time a purchase transaction occurs, the customer is required to authenticate themselves with the Internet Services (e.g., Yahoo Purse) by inputting an established user ID and password etc.

### SUMMARY OF THE INVENTION

The present principles propose a mechanism to create a billing agent within a customer's access point (i.e., an internet service provider—ISP) account so that customer can use their account with the access network to pay for fee-based Internet services.

In the public domain, a customer must have an access network account (i.e., the ISP subscription) in order to access the Internet. The credibility and authentication is always checked at the time of each access. Therefore, it is convenient for a customer to use their ISP account to pay for small charges from Internet services. There is no need to have per transaction authentication and the service is not necessarily bundled with the ISP in a static way.

By taking advantage of the existing relationship between the user and the access network, either the service providers or the access point can initiate transactions between them on behalf of the user. This eliminates the need to open an account or type in a credit card number each, time the user orders a service or product. This can significantly increase the usage of these services that were previously avoided due to the cumbersome purchase process.

The present principles proposes a solution of using access point service provider (e.g., Internet service provider, ISP) as a billing agent to receive micro-billing on behalf of pay Internet services. The micro transaction can be billed together with the monthly subscription fee of the customer's ISP. This solution is secure and provides a mode convenient method for conducting online transaction for the ISP customers.

According to one implementation, the method for online billing includes establishing a micro-billing agent at a user's access point, and establishing a micro-billing filter at the access point. The micro-billing agent contains billing information for the user that remains exclusively contained within the micro-billing agent and is exclusively used for online transactions, while the micro-billing filter operates to detect the presence of a micro-billing transaction identification for the micro-billing agent.

In this configuration, the method further includes receiving a user selected purchase page at the micro-billing agent, detecting presence of a micro-billing transaction identification in the form of a micro-billing label associated with the selected purchase page, establishing a secure session between the micro-billing agent and a micro-billing server at an online store, and forwarding the selected purchase page to the online store.

According to another implementation, the method for conducting online billing transactions includes establishing a micro-billing agent at a user's internet service provider, receiving a user selected purchase page at the micro-billing agent, sending a URL embedded with a micro-billing label from the micro-billing agent to a web server corresponding to an online store associated with the selected purchase page, and receiving an invoice and signature confirmation at the micro-billing agent from a micro billing server corresponding to the online store. In this implementation, the user selected purchase page contains a selected micro-billing option.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a block diagram of the components of a micro-billing system in a customer's access (ISP) point according to an implementation of the present principles;

FIG. 2 is a block diagram of the method for providing micro-billing in a customer's access (ISP) point according to an implementation of the present principles;

FIG. 3 is a block diagram of the method for providing micro-billing in a customer's access (ISP) point according to another implementation of the present principles; and

FIG. 3b is a block diagram of the method for providing micro-billing in a customer's access (ISP) point according to another implementation of the present principles.

### DETAILED DESCRIPTION OF PREFERRED EMBODIMENTS

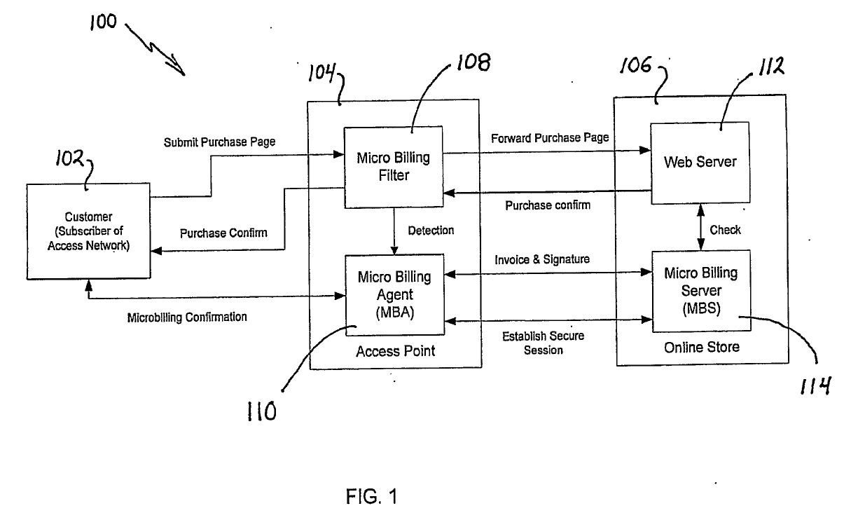

FIG. 1 shows the components of a micro billing system 100 in an access network according to an implementation of the present principles. A customer 102 is the subscriber of an access point 104 (e.g., an ISP provider), and uses their web browser as the interface to make an online purchase. The access point 104 is in bi-directional communication with at least one online store 106.

According to one aspect of the present principles, it is important for the micro-billing system 100 to avoid transaction disputes after the fact, since three parties are involved in the purchase transaction (i.e., customer, access point, online store). To avoid disputes, the micro-billing system 100 follows the following rules:
1. The access point (i.e., ISP) 104 needs to obtain a signed confirmation for a customer's micro-billing transaction; and
2. The online store 106 needs to obtain an authentication and a signed invoice from the access point (ISP) 104 for each transaction.

In accordance with one implementation of the present principles, the access point 104 includes a micro-billing filter 108 and a micro-billing agent (MBA) 110. The micro-billing filter 108 is configured to detect transport and/or application layer information for micro-billing. This information is used for a micro-billing agent (MBA client) to contact the micro-billing server (MBS) 114 on the web server 112 of the online store 106.

According to one aspect of the present principles, the micro-billing agent (MBA) 110 is configured to contain billing information for the user, and in particular, billing information that is exclusive to this user and is for online transactions the user may initiate with micro-billing enabled online stores, or other online services that accept the micro-billing established in by the MBA within the user's access point or ISP.

Those of skill in the art will recognize that one of the primary advantages of the present principles, is there is no need to have a static business relationship between the user's ISP (i.e., access point) and the online store. There is a clear understanding and assumption that the ISP is a trustworthy source, especially when the ISP is a larger organization, such as, for example, America Online (AOL®). Thus, the online stores would be more willing and accepting of such a micro-billing arrangement as provided by the present principles.

The following is a sample procedure of a micro-billing transaction according to an exemplary implementation of the present principles. Initially, a customer submits a purchase page that contains a micro-billing label. The micro-billing label can be, for example, a special tag field or URL string, or port number indicating server micro-billing support. Although there are many ways for embedding micro-billing information, the following are shown for exemplary purposes only:
1. As an XML tag field in the html page header section, for example, “<microbilling>url=MBS_URL, id=transactionID </microbilling>”;
2. A pre-defined, standard string in the URL, for example, http://www.onlinestore.com/micro$billing.asp ?id=transactionID; or
3. A standard transport port in the URL, for example, http://www.onlinestore.com/purchase.asp:8088 ?id=transactionID.

The submitted page with the label (i.e., tag field, special string or special port) is detected by the micro billing filter 108 at the access point 104. The micro billing filter 108 sends the page information, including at least a transaction ID and the URL of the online store to the MBA 110. The MBA 110 queries the customer to confirm it is a micro-billing transaction and to obtain the customer's signature on this particular URL/transaction ID combination. This confirmation can be achieved in many different ways, for example, through a popup window.

The MBA 110 then contacts the micro billing Server (MBS) 114 at the online store 106 and establishes a secure session. By establishing the secure session, the MBS 114 can authenticate the MBA/access point at the same time. Thus, it is clear that according to the present principles, it is not necessary for the MBA to authenticate the MBS for the system to work.

Based on the transaction ID that the MBA 110 sends to the MBS 114, the MBS 114 can send an invoice to the MBA 110 for signature. The MBA 110, having received the customer's micro-billing conformation, can provide the requisite signature to the MBS 114. Once the invoice and request for signature is received by the MBA 110, the purchase page is then forwarded to the web server 112 from the micro billing filter 108 at the access point 104. The web server 112 then checks with the MBS 114 to determine if this transaction has been paid by micro-billing. If yes, the server will simply return a purchase confirmation page back to the customer. If no, the server may post alternative payment methods for the customer to select from. It will be apparent from the description herein, that the reference to the customer “signature” is an electronic signature provided by the customer, or directly from the customer authorized MBA depending on the particular implementation of the present principles.

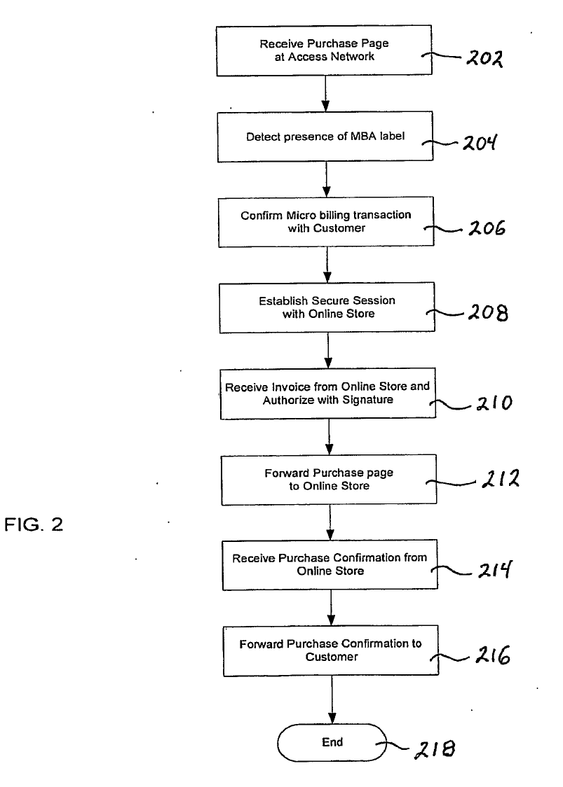

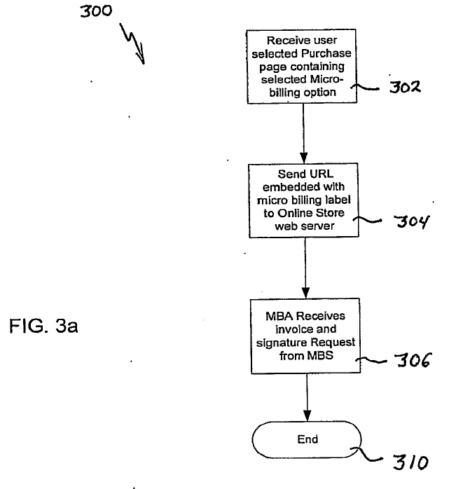

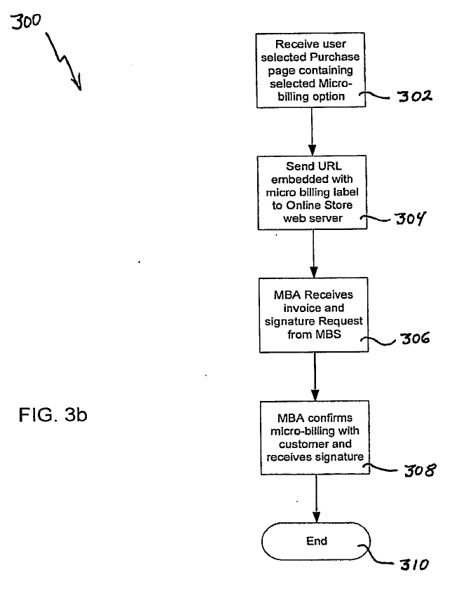

The micro billing server MBS 114 can be an independent server from the online store server (as shown), or the MBS may be one of many different applications that runs on the online store server 112. The MBS can be accessed through a URL embedded in the micro-billing identification in the purchase page, as will be described below with respect to FIGS. 2-3b.

According to one aspect, the concepts of the MBA at the access point becomes attractive, as there will be a monetary commission that the access point can earn for providing the micro billing service. For example, the monetary commission for an access point (i.e., ISP) on a transaction can be negotiated dynamically or according to a standard that the ISP publishes. The invoice should contain the price for the customer and the commission for the ISP. The difference is what would be paid to the online store.

To ensure billing security, the authentication of the MBA is an integral feature of the present principles. For example, a standard public/private key can work safely in this case. However, with larger ISPs, they may not want their private key distributed to MBAs at thousands of locations. As such, the MBA may need to have a secure channel to a centralized server of the ISP to obtain the signature.

Referring to FIG. 2, there is shown the method 200 of micro billing by an agent (MBA) 110 of the Access Point 104 according to an implementation of the present principles. Initially, the micro billing filter 108 receives the purchase page containing a micro billing label from the customer (202). The micro-billing filter 108 detects (204) the presence of the MBA label and indicates such detection to the MBA. The MBA 110 then confirms (206) the micro-billing transaction with the Customer. Once confirmed, the MBA 110 establishes (208) a secure session with the online store. The access point 104 then receives (210) an invoice and signature authorization request from the online store. Upon receipt of the invoice and authorization request, the access point 104 forwards (212) the purchase page with the MBA label to the online store 106. The access point then receives (214) a purchase confirmation from the online store, and forwards (216) the same to the customer. The transaction is then completed 218.

As mentioned above, alternative methods for the MBA 110 to confirm with a customer the micro-billing transaction and obtain the customer's signature can be employed without departing from the spirit of the present principles. For example, instead of directly confirming with customer, which requires a web server function on the MBA, the MBA can obtain the confirmation through the micro-billing service MBS 114. In this implementation, the purchase page would explicitly include an option of micro-billing with corresponding terms and conditions. By way of example, this implementation is shown in the method 300 of FIG. 3a. As shown, the access point receives (302) a customer selected purchase page containing the user selected micro-billing option on the purchase page. The MBA then sends (304) a URL embedding the micro-billing label to the web server 112 of the online store 106. The micro billing server 114 of the online store 106 then sends (306) an invoice and signature request to the MBA. As expected, a signature of the customer should be required by the web server of the online store for this transaction. Thus, when the MBS sends (306) the invoice to the MBA, it can include a signature of the customer for this transaction as well (i.e., the customer's signature would be provided when the customer selects the micro-billing option). Alternatively, as shown in FIG. 3b, the MBA can confirm (308) the micro-billing with the customer and receives the signature confirming that the customer wants to use micro-billing. The transaction is then completed 310. According to one aspect, when the MBS 114 sends the invoice, it expects the invoice file sent back from the MBA with, for example, the ISP private key. In this instance, the signature request is clearly implied by the MBS sending the invoice to the ISP.

Another benefit for this micro billing method is that it prevents online stores from obtaining the customer's personal information at the ISP through online purchases. Without the micro billing of the present principles, a customer making a purchase at an online store must give the store his/her important information, such as name, address, phone number and credit card number. An online store can figure out which ISP that a customer is using by obtaining a range of IP addresses of an ISP. This creates the possibility that an ISP can open an online store to collect other ISP's customer information. Using micro-billing of the present principles, the customer information is hidden behind their own access point (i.e., ISP) since no important information is released to an online store in order to make a purchase.

Furthermore, the micro-billing of the present principles eliminates the potential for a customer conflict with the online store, thereby increasing customer confidence when purchasing online. For example, with the micro-billing of the present principles, the potential for a dispute exists between: (1) a customer and his/her ISP; or (2) an online store and the ISP. In both cases, since the customer's signature is obtained for the transaction, there is no need to release the third party information to resolve the dispute.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

It is to be understood that the present principles may be implemented in various forms of hardware, software, firmware, special purpose processors, or a combination thereof. Preferably, the present principles may be implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

While there have been shown, described and pointed out fundamental novel features of the present principles, it will be understood that various omissions, substitutions and changes in form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

1. A method for online billing comprising the steps of:
providing billing information for a user to a micro-billing agent at a an access point, said micro-billing agent containing billing information that remains exclusively contained within the micro-billing agent for online transactions; and
detecting a presence of a micro-billing transaction identifier at the access point, by using a micro-billing filter where the micro billing agent uses the micro-billing transaction identifier externally of said access point to conduct a transaction without transmitting said billing information externally of said access point.

2. The method of claim 1, further comprising the steps of:
receiving a user selected purchase page at the micro-billing agent;
detecting presence of a micro-billing transaction identifier in the form of a micro-billing label associated with the selected purchase page;
establishing secure session between the micro-billing agent and a micro-billing server for an online store; and
forwarding the selected purchase page to the online store.

3. The method of claim 2, wherein said receiving a user selected page comprises receiving the purchase page from an online store that uses said micro-billing transaction identification in its purchase pages.

4. The method of claim 2, further comprising confirming micro-billing transaction with the user selecting the purchase page after detection of the micro-billing label.

5. The method of claim 2, further comprising:
receiving at least one of an invoice and a signature request from the micro-billing server of the online store at the micro-billing agent after the secure session has been established; and
forwarding a purchase confirmation to the user from the micro-billing agent when received from the micro-billing server of the online store.

6. The method of claim 2, wherein said micro-billing label indicates server micro-billing support and comprises at least one of a special tag field, a Uniform Resource Locator (URL) string, and a port number.

7. A method for conducting online billing transactions comprising the steps of:
establishing a micro-billing agent;
receiving a user selected purchase page at the micro-billing agent, containing a selectable micro-billing option;
sending a Uniform Resource Locator (URL) embedded with a micro-billing label from the micro-billing agent to a web server corresponding to an online store associated with the selected purchase page; and
receiving an invoice and signature confirmation at the micro-billing agent from a micro billing server corresponding to the online store.

8. The method of claim 7, further comprising:
establishing a secure session between the micro-billing agent and the micro billing server for the online store in response to a received user confirmation for micro-billing.

9. The method of claim 7, further comprising establishing a micro-billing filter at the access point, said micro-billing filter for detecting the presence of a micro-billing label associated with a selected purchase page.

10. The method of claim 9, wherein said micro-billing label indicates server micro-billing support and comprises one selected from a group consisting of a special tag field, a URL string, and a port number.

11. A program storage device having an application program for use in a computer tangibly embodied thereon, including instructions for performing at least the following:
establishing a micro-billing agent at an access point, said micro-billing agent containing billing information corresponding to a user, wherein said billing information remains exclusively contained within the micro-billing agent for online transactions; and
establishing a micro-billing filter at the access point, said micro-billing filter for detecting the presence of a micro-billing transaction identification for the micro-billing agent.

12. The program storage device of claim 11, wherein the application program further includes instructions for performing at least the following:
receiving a user selected purchase page at the micro-billing agent;
detecting presence of the micro-billing transaction identification in the form of a micro-billing label associated with the selected purchase page;
establishing secure session between the micro-billing agent and a micro-billing server at an online store; and
forwarding the selected purchase page to the online store.

13. The program storage device of claim 12, wherein the application program instructions for performing said receiving a user selected purchase page, further includes instructions for performing at least the following: receiving the purchase page from an online store that uses said micro-billing transaction identification in its purchase pages.

14. The program storage device of 12, wherein the application program further includes instructions for performing at least the following: confirming micro-billing transaction with the user selecting the purchase page after detection of the micro-billing label.

15. The program storage device of claim 12, wherein the application program further includes instructions for performing at least the following:
receiving an invoice and a signature request from the micro-billing server of the online store at the micro-billing agent after the secure session has been established; and
forwarding a purchase confirmation to the user from the micro-billing agent when received from the micro-billing server of the online store.

16. The program storage device of claim 10, wherein the micro-billing label indicating server micro-billing support and comprises at least one of a special tag field, a Uniform Resource Locator (URL) string, and a port number.
